(19) United States
(12) Patent Application Publication
(10) Pub. No.: US 2008/0011145 A1
(43) Pub. Date: Jan. 17, 2008

(54) Insertable saw tooth

(76) Inventor: Andre M. Ludwig, Thunder Bay (CA)

Correspondence Address: ADE & COMPANY INC., 2157 Henderson Highway, WINNIPEG, MB, R2G1P9, US

(21) Appl. No.: 11/486,435

(22) Filed: Jul. 14, 2006

(51) Int. Cl. B27B 33/12

(52) U.S. Cl. 83/835; 83/838

(57) ABSTRACT

An insertable tooth for wood-cutting apparatus features a blade with a front surface having side edges extending parallel to a radius of a disc in which the tooth is inserted and positioned ahead of the rest of the blade so that the front surface side edges lead the tooth as the disc rotates in a predetermined direction. The cutting edge of the blade extends along the most radially outward extent of a region connecting the two front surface side edges and being positioned rearwardly therefrom. A top surface and the front surface each feature two side faces disposed on opposite sides of a planar central face. On the top surface, each side face extends radially inwardly from a top surface side edge to the central face. On the front surface, each side face extends rearwardly away from one of the front surface side edges to the central face.

This invention relates to wood-sawing apparatus, particularly slashers that render logs suitable for processing, for example by paper pulp manufacturers.

### BACKGROUND OF THE INVENTION

Slashers are machines commonly found in the forest industry on which saws are used to reduce the length of trees to logs of suitable size for processing in lumber mills, plywood mills, paper mills, oriented strandboard (OSB) mills, etc. It should be appreciated however that the present invention is not limited to such particular applications and may be used in any operation where it is desirable or necessary to crosscut wood, for example to make firewood.

A slasher may include a rotating disc that has slots into which replaceable teeth are inserted. Cutting is accomplished by beveled tooth surfaces or by hard (e.g. carbide) blade members brazed to the ends of the teeth. As the blades wear out, the teeth are removed from the slots and replaced or reconditioned by replacing the carbide blade member.

One such slasher is disclosed in Reed U.S. Pat. No. 4,084,470. The teeth in Reed are elongated and have a “cubic trapezoid” blade brazed into a notch at the radially outward end of the tooth. The face of the blade is planar and parallel to a disc radius, and the sides of the blade are relieved from the base at an angle of from 2 degrees to 20 degrees. Each of the blades is positioned in the same rotational plane and at the same radial distance from the axis of disc rotation.

Applicant's U.S. Pat. No. 4,765,217 teaches a carbide slasher tooth blade having front surface side edges extending in a radial direction and a connecting region between the side edges and disposed rearwardly therefrom. A connecting edge along the radially outermost extent of the connecting region intersects with the side edges to create cutting points at the radially outermost extent of the blade. The tooth eliminates the need to stagger left-handed and right-handed blades and improves efficiency by increasing the available amount of cutting edge. The top surface of the blade is either double-beveled or concave.

U.S. Pat. No. 5,139,064 of Nunweiler teaches a tooth for a tree-felling saw head including a body portion having a lead cutter and a trailing primary cutter. Lead cutters of neighbouring teeth on the saw head cooperate to cut a narrow side wall kerf together with inside corners of a larger principal kerf. Following primary cutters cut out the remainder of the larger kerf formaing a square cut end. Efficiency is improved as the combined primary cutters separate the longitudinal fibers of the tree without double cutting the fibers.

U.S. Pat. No. 5,855,157 of Okamura et al. teaches a saw blade having a combination of cutting teeth and biting teeth. The biting teeth are disposed, on a cut path mainly by means of the cutting teeth, either on a top surface of or in front of each cutting tooth and are smaller in width than the cutting teeth. In the same sawing step, a biting operation and cutting operation are carried out by the biting and cutting teeth respectively to prevent fluff or return of fibers from occurring.

Other references concerning saws with insertable teeth are discussed below.

Kendall U.S. Pat. No. 1,141,063 and McClean U.S. Pat. No. 1,105,153 disclose teeth having sharpened edges (rather than carbide blades) on faces that are beveled with respect to the direction of rotation; edges of adjacent teeth around the circumference are beveled in opposite directions.

Hiltebrand U.S. Pat. No. 3,071,027 discloses a circular saw having an insertable support member and a hard-steel cutting blade. The blade “is formed symmetrically with respect to the central plane of the disc”and its top is provided with a V-shaped groove that is an extension of a support-member groove used to guide the member into the disc. The blade “ensures a perfect guiding of the saw blade in the work piece”. There is no indication that the front of the blade is grooved to form a beveled cutting surface.

Phillips U.S. Pat. No. 560,426 discloses a tooth with a longitudinal groove and a straight chisel edge (8 in FIG. 6) perpendicular to the radius and to the direction of rotational movement. At the top of the tooth, the outside edges (7 in FIG. 5) found at the end of the groove are rounded and then sharpened to form the chisel edge (see col. 2, lines 87-103).

Thornton U.S. Pat. No. 2,160,525 discloses another insertable tooth having blades that can be fixed to a rotating disc. The angle of the blades can be adjusted.

Evancic U.S. Pat. No. 3,885,488 discloses insertable teeth that are angled in the direction of rotation and have a symmetrically angled cutting edge.

Other saws having removable teeth include Roberts, U.S. Pat. No. 2,703,118 disclosing a tooth 7 mounted on an interlocking rounded member 8. Kolesh et al. U.S. Pat. No. 3,270,786 discloses a replaceable cutting bit 13 locked into a socket 12 of a saw plate by means of a generally rounded shank 14. Beckner U.S. Pat. No. 3,004,902 also discloses bit 20 comprising a head 22 and a shank 30 to be inserted in a generally rounded socket 11.

### SUMMARY OF THE INVENTION

According to a first aspect of the invention there is provided a wood-cutting apparatus comprising a disc rotatable about an axis in a prede rotational direction, the disc having a plurality of teeth, and each tooth comprising a blade member positioned radially outwardly on the disc, the blade member comprising:

(a) a front surface having a first front surface side edge and a second front surface side edge, each front surface side edge extending in a generally radial direction, the front surface edges being spaced from each other in a direction generally parallel to the axis;

(b) a central front surface connecting region positioned between the first and the second front surface side edges, the front surface connecting region being positioned rearwardly from the front surface side edges in the rotational direction;

(c) a connecting edge extending along a most radially outward extent of the front surface connecting region, the connecting edge forming a first cutting point at its intersection with the first front surface side edge and a second cutting point at its intersection with the second front surface side edge; each of the front surface side edges extending radially outwardly further than the connecting edge; and

(d) a top surface extending from the connecting edge rearwardly, away from the direction of rotation, the top surface slanting radially inwardly front-to-rear;

the top and front surfaces each comprising two side faces disposed on opposite sides of a central face, each side face of the top surface extending radially inwardly from one of the top surface side edges to the central face of the top surface, each side face of the front surface extending rearwardly away from the rotational direction from one of the front surface side edges to the central face of the front surface; and

the central faces being generally planar and meeting to define a linear segment of the connecting edge extending parallel to the axis.

According to a second aspect of the invention there is provided a tooth for insertion in a wood-cutting apparatus that comprises a disc rotatable in a predetermined direction on an axis, the tooth comprising a blade, the blade comprising:

(a) a front surface having a first front surface side edge and a second front surface side edge, each front surface side edge extending in a generally radial direction, the front surface edges being spaced from each other in a direction generally parallel to the axis;

(b) a central front surface connecting region positioned between the first and the second front surface side edges, the front surface connecting region being positioned rearwardly from the front surface side edges in the rotational direction;

(c) a connecting edge extending along a most radially outward extent of the front surface connecting region, the connecting edge forming a first cutting point at its intersection with the first front surface side edge and a second cutting point at its intersection with the second front surface side edge; each of the front surface side edges extending radially outwardly further than the connecting edge; and

(d) a top surface extending from the connecting edge rearwardly, away from the direction of rotation, the top surface slanting radially inwardly front-to-rear;

the top and front surfaces each comprising two side faces disposed on opposite sides of a central face, each side face of the top surface extending radially inwardly from one of the top surface side edges to the central face of the top surface, each side face of the front surface extending rearwardly away from the rotational direction from one of the front surface side edges to the central face of the front surface; and

the central faces being generally planar and meeting to define a linear segment of the connecting edge extending parallel to the axis.

The tooth of the present invention shares some of the advantages of Applicant's previously patented tooth, but improves the efficiency of a cutting apparatus by providing the linear segment of the connecting edge between the cutting points. The parallel relationship between this linear segment and the disc's rotational axis orients the linear segment generally parallel to wood fibers during a cross-cutting operation. The result is that cutting of the fibers does not occur along this linear segment of the connecting edge, but only at portions of the connecting edge extending radially outward with respect to the disc's rotational axis. The fibers are thus cut only near the sides of the kerf to dislodge a portion of the fiber from the wooden body being cut so that it can subsequently be carried away by the linear segment of the connecting edge. As the majority of energy required for a sawing operation is exhausted in the actual shearing of fibers, the present invention improves efficiency by reducing the number of times each fiber is actually cut.

Preferably each side face is generally planar.

Preferably the cutting edge comprises a linear segment extending parallel to the axis.

Preferably a length of the central face of the top surface, measured in the direction of rotation, is uniform between the side faces of the top surface.

Preferably the central face of the top surface between the side faces of the top surface is rectangular.

Preferably a thickness of the blade, measured in the direction of rotation, is uniform between the side faces of the top surface.

The strength of the tooth blade of the present invention is improved over that of Applicant's previously patented tooth by the uniform thickness across the central face of the front surface. In the prior art teeth, the thickness of the blade tip at a midplane of the tooth normal to the discs rotational axis is significantly reduced relative to areas near the side edges by the double beveled or concave shape of the front surface. This reduced thickness may increase the likelihood of failure of the blade tip at this midplane, thereby increasing the frequency of blade or tooth replacement. Due to present invention's uniform thickness across the central face of the top surface, this thickness can be made greater than that at the midplane of the prior art teeth without increasing the overall size of the blade. This improves the blade's strength to extend the life of the tooth and reduce replacement frequency.

Preferably the front surface further comprises a chip ejector extending between the side faces of the front surface at an end of the central face of the front surface opposite the connecting edge.

Preferably a leading edge of the chip ejector nearest the connecting edge and extending between the side faces of the top surface is curved.

### BRIEF DESCRIPTION OF THE DRAWINGS

In the accompanying drawings, which illustrate an exemplary embodiment of the present invention:

FIG. 1 is a highly diagrammatic side view of a wood slasher with insertable teeth.

FIG. 2 is an enlarged side view of a part of the slasher of FIG. 1.

FIG. 3 is a side view of a portion of an insertable tooth of the slasher of FIG. 1.

FIG. 4 is a front view of a portion of the tooth of FIG. 3.

FIG. 5 is a rear view of a portion of the tooth of FIG. 3.

FIG. 6 is a top view of a portion of the tooth of FIG. 3.

FIG. 7 is a bottom view of the tooth of FIG. 6 partly in section.

FIG. 8A is a front view of the blade of the tooth shown in FIGS. 3-7.

FIG. 8B is a rear view of the blade of FIG. 8A.

FIG. 8C is a top view of the blade of FIG. 8A.

FIG. 8D is a bottom view of the blade of FIG. 8A.

FIG. 8E is a side view of the blade of FIG. 8A.

FIG. 8F is a cross section of the blade of FIG. 8A taken along line F-F of FIG. 8A.

FIG. 9 is a front view of an alternate tooth for use in the slasher of FIG. 1.

FIG. 10 is a partial cross section of the tooth of FIG. 9 as taken along line 10-10 of FIG. 9.

FIG. 11 is a partial side view of the tooth of FIG. 9.

FIG. 12A is cross-sectional view of a kerf cut by a blade of a tooth of the present invention.

FIGS. 12B and 12C are cross sectional views of kerfs cut by blades of prior art teeth.

### DETAILED DESCRIPTION

### Structure

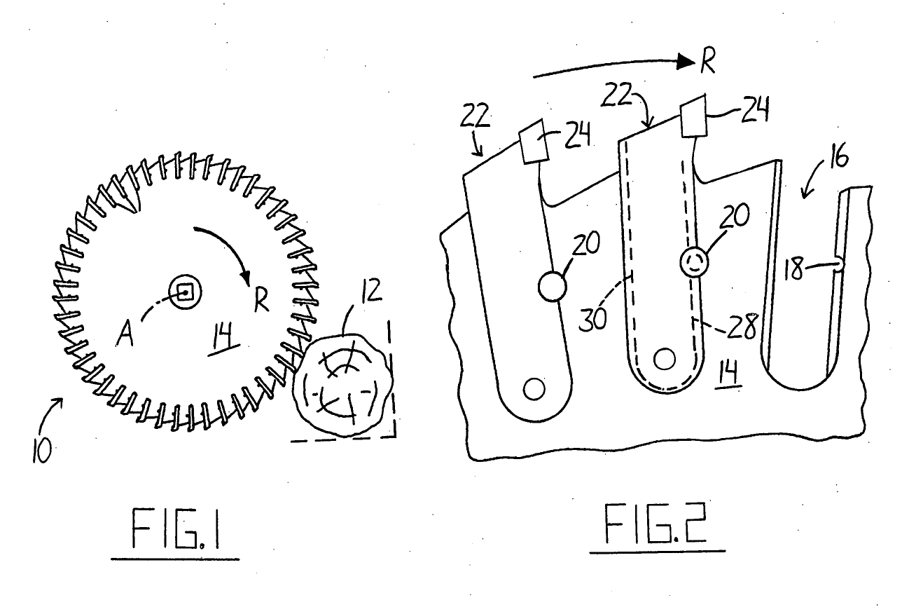

In FIG. 1, slasher 10 is intended for slashing log 12 into blocks of a uniform length suitable for use in a paper pulp mill. Log 12 is advanced as the blocks are cut and slasher 10 has a disc 14 that rotates on a central axis A perpendicular to disc 14 in the direction of rotation designated by arrow R. Reed U.S. Pat. No. 4,084,070, which is hereby incorporated by reference, discloses an example of suitable advancement and disc-drive mechanisms.

A portion of the periphery of slasher disc 14 is shown in FIG. 2 and has multiple elongated slots 16 (one of which is labeled) shaped to receive insertable teeth. Slots 16 include a rounded indentation 18 to receive a cylindrical locking dowel 20 that fixes each tooth in the slot.

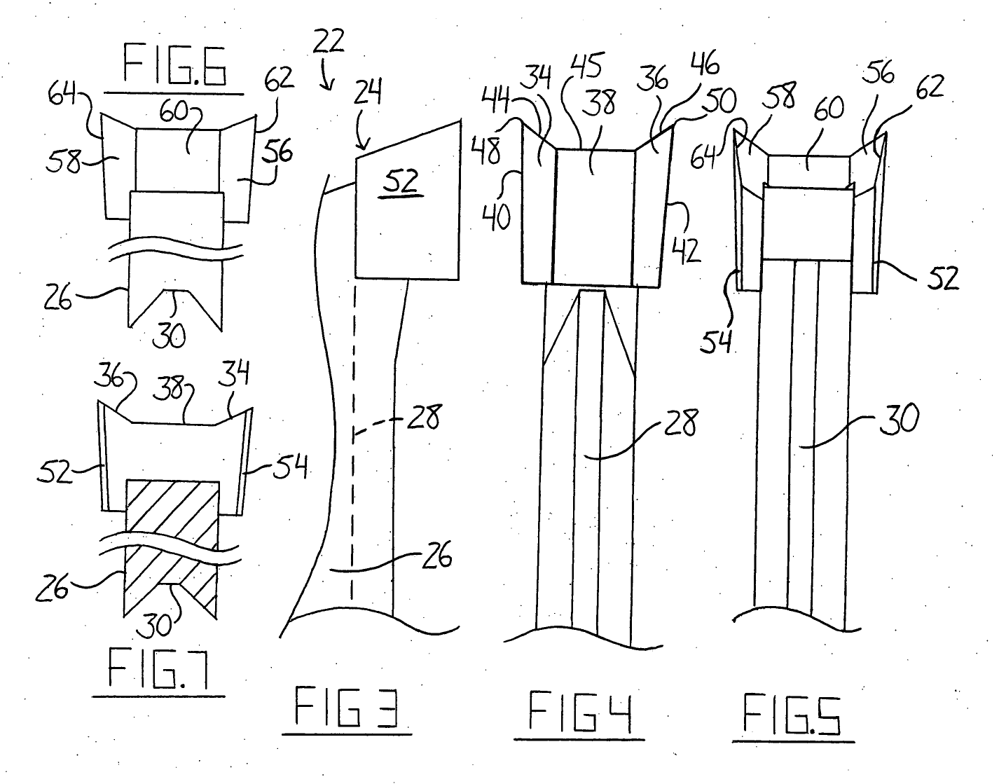

FIGS. 3-8 show one embodiment of a tooth 22 for insertion in slot 16. Tooth 22 has a blade portion 24 that is brazed in position at the front (i.e., facing the direction of rotation) of the radially outward end of a plate 26. Blade portion 24 is a tungsten carbide cutting element. Plate 26 can be a softer, cheaper steel.

Plate 26 is elongated and flat, having guide slots 28 and 30 in its front and rear edges, respectively. A rounded indentation 32 cooperates with indentation 18 and dowel 20 to fix the tooth in place. The top of plate 26 angles radially inwardly from the front to the back of the plate.

Blade 24 is shaped to have a front surface comprising a first planar side face 34 and a second planar side face 36 that each meet with a planar central face 38 extending generally radially along the front blade surface. Side faces 34 and 36 extend sidewardly and forwardly from central face 38 to side edges 40 and 42, respectively. Edges 40 and 42 extend radially outward to a greater extent than does central face 38, so that the blade face has an inverted trapezoid shaped recess at the top surface. As described below, edges 44 and 46 of the top surface are the primary cutting edges of the blade, and edges 40 and 42 establish the width (or kerf) of the cut. Connection of the side edges 40 and 42 by the cutting edges 44 and 46 is completed by a linear edge segment 45 extending parallel to the disc axis between the cutting edges 44 and 46.

Cutting points 48 and 50 are formed, respectively, by the intersection of edges 40 and 44 on one side and by edges 42 and 46 on the other side. As the slasher disc 14 rotates, points 48 and 50 are first to contact the wood, piercing and shearing wood fibers running longitudinally along log 12 (i.e. perpendicular to the cut of slasher 10). As the disc rotates, shearing continues along edges 44 and 46 which are angled rearwardly and radially inwardly from the points. Specifically, radial inward angling is demonstrated by angle a formed between the central face 60 of the top surface and each of the side faces 58 and 56 thereof within the plane of the front surface central face 38. Angling rearwardly away from the direction of rotation R is demonstrated by angle β formed between the central face 38 of the front surface and each of the side faces 24 and 36 thereof within a plane extending through the blade parallel to the disc axis and normal to the front surface central face 38. Angles αand βare each preferably between 145° and 165° and most preferably about 155°.

Blade 24 is wider and extends further radially than does plate 26, and blade 24 includes various beveled surfaces to provide a smooth transition to plate 26. Specifically cutting or back clearance is provided at the sides of the blade by a beveled surface 52 (FIG. 3) and a corresponding surface 54 on the opposite side of the blade. The top surface features side faces 56 and 58 and central face 60 corresponding to the side and central faces of the front surface. The faces 56, 58 and 60 of the top surface slant radially inwardly (front-to-back) at about the same angle as the top of plate 26. The top surface side faces 56 and 58 each also slant radially inwardly along a direction parallel to the disc axis from respective side edges 62 and 64 of the top surface to the central face 60.

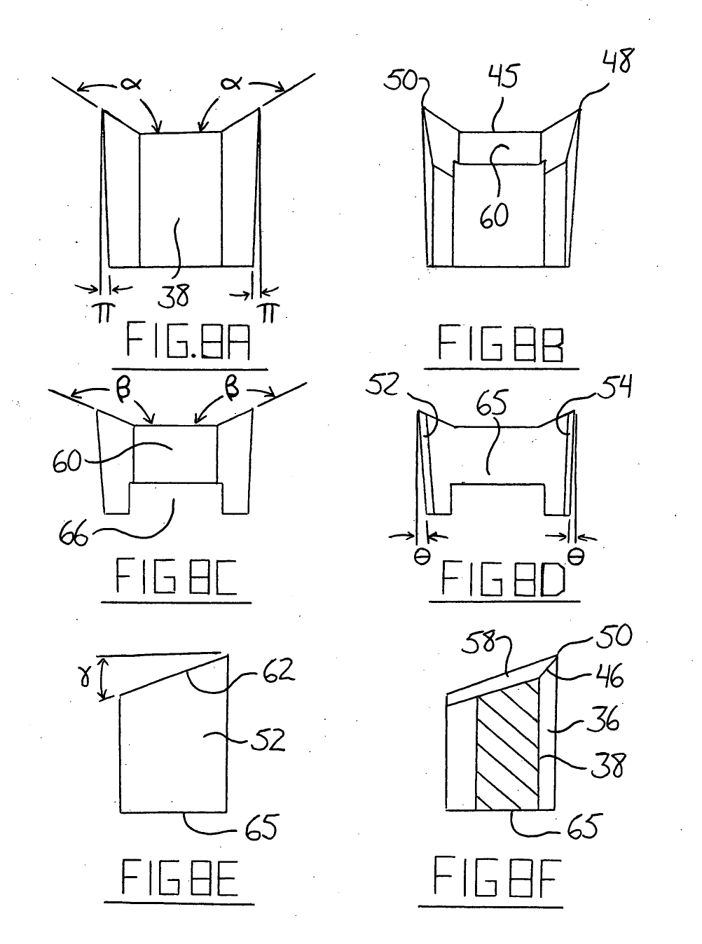

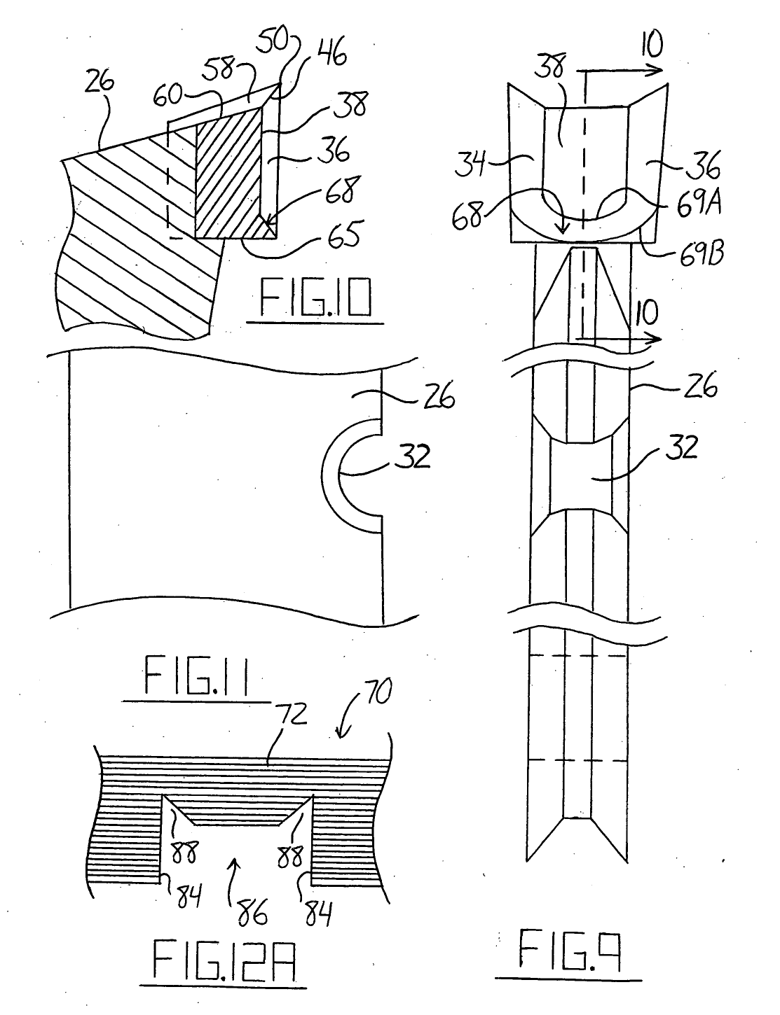

FIGS. 8A-8F show the various angles of the surfaces of the blade of FIGS. 3-8. These angles are selected to allow high feed rate and to produce large integral chips when cutting through wood fibers (i.e. across the grain). Preferred angles are as follows:

| Angle | Value of Angle |
|---|---|
| α | 145°–165° (preferably about 155°) |
| β | 145°–165° (preferably about 155°) |
| γ | 10°–40° (preferably about 20°) |
| θ | 1°–5° (preferably about 3°) |
| π | 1°–5° (preferably about 2°) |

The angle selection is important in making the saw tip durable as well as effective in severing wood fibers. Specifically, the front-to-rear taper (angle π) and the top-to-bottom taper (θ) on the side surfaces, as well as the bevel on the top (angle Γ), allow clearance. The side face angles α and β of the top and front surfaces respectively determine the sharpness of cutting points 52 and 53.

Preferably the tooth width is about 10× to 1× the length of the wood fibers being cut. The resulting chips are large, integral pieces of wood, reducing the heat and binding caused by excessive sawdust. In particular, the tip enables ejection of the chip, and avoids the need for a so-called “raker”, a blunt, non-cutting tooth that clears the area cut by previous teeth.

Blade 24 is configured to fit into a slot in the front of plate 26 and around the sides of the plate. As best shown in FIG. 7 the blade sides extend rearwardly to form a notch 66 that accommodates plate 26.

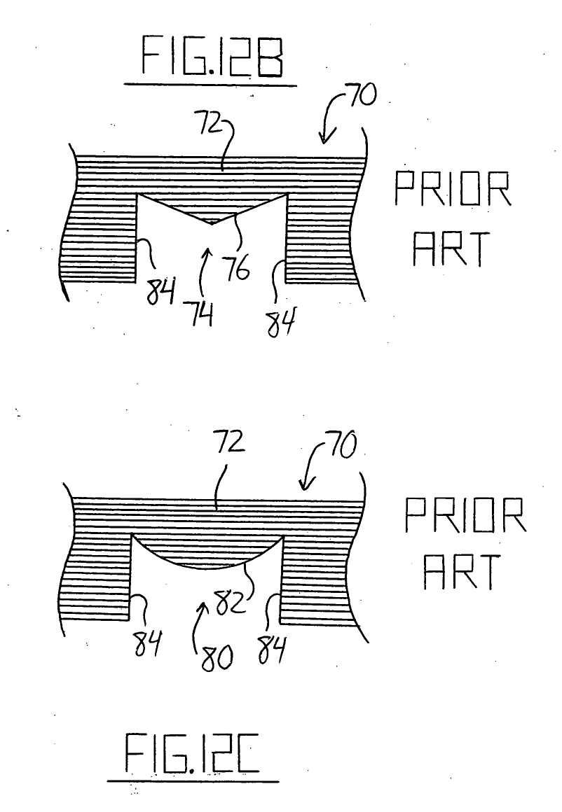

The alternate embodiment depicted in FIGS. 9 to 11 is identical to the embodiment of FIGS. 3-8, except that the front surface of the blade 24 features a chip ejector 68 in the form of a lip extending between the front surface side faces 34 and 36 along a bottom end of the front surface opposite the cutting edges and top surface. The chip ejector extends forward and radially inward from the central face 38 of the front surface and curves upward at either side of the blade to meet with the respective front surface side face. At the ends of the upwardly concave chip ejector, its upper edge 69A joins with the edges along which the central face 38 and side faces of the front surface meet and its lower edge 69B joins with the side edges 40 and 42. The chip ejector and side faces of the front surface are thereby integral to provide a smooth continuous surface extending along the periphery of the front surface in an upward opening U-shape as viewed from the front of the tooth.

The use of flat bottom surface 65 which mates with a notch on plate 26, as illustrated in FIG. 10, enables lateral and radial alignment of the tooth.

The following description of Manufacture and Operation applies generally to each of the embodiments described above.

### Manufacture

Blade 24 is hard tungsten carbide, made by known techniques. Specifically, blade 24 is made by compressing the ingredients in a mold of the desired form and then sintering to fuse the ingredients using techniques known in the art. Plate 26 is made by investment casting or by traditional wrought manufacturing methods known in the art. Blade 24 is seated in the slots on the front of plate 26 and brazed in place.

### Operation

When a number of blade/plate assemblies are fixed in the slots of a saw disc, the slasher can be operated by standard techniques to produce a wood product useful in pulp manufacture. Spacing between the teeth can be the same as is used for a given rotational velocity with conventional teeth.

FIGS. 12A-12C show cross sectional portions of a tree 70 having longitudinal fibers 72 illustrating kerfs cut by a tooth of the present invention and prior art teeth of Applicant's previous patent. The prior art tooth forming the kerf of FIG. 12B features a double beveled top surface that creates a kerf 74 having a V-shaped end wall 76. The prior art tooth forming the kerf of FIGS. 12C features a concave top surface that creates a kerf 80 having an arcuate end wall 82. From the figures, it should be appreciated that each of these prior art teeth feature cutting edges extending the full width of the tooth and therefore cut the fibers 72 multiple times between the sidewalls 84 of the kerf. Looking at FIG. 12A however, it should be appreciated that cutting of the fibers 72 occurs only along a fraction of the width of a tooth according to the present invention. Cutting occurs only along the cutting edges 44 and 46 between the cutting points 48 and 50 and the linear edge segment 45 formed between the central faces 38 and 60 of the front and top surfaces respectively. This creates triangular notches in the end wall of the kerf 86 at the sidewalls 84 thereof, leaving the rest of the fiber 72 intact. In other words, the fiber is cut only near the sidewalls 84 of the kerf rather than across its entire width. A portion of a fiber is thereby sheared at opposite ends to separate it from the rest of the fiber, and then as disc rotates and the cut deepens, the portion is dislodged by the linear edge segment 45 and carried away. By orienting a portion of the connecting edge between the side edges of the blade parallel to the disc axis, and thus parallel to the log fibers, the cutting efficiency is improved by shearing the fibres only at the sides of the kerf rather than across its entire width. This removal of fibers with an edge parallel thereto reduces the power demand of the saw by an estimated 10 to 20 percent depending on the hardness of the wood.

The shape of the blade tip of the tooth of the present invention also has improved strength over those of Applicant's previous patent. The concave or double beveled top surfaces of the prior art tooth blades created reduced thickness, or length, measured rearward (with respect to the direction of disc rotation) from the front surface at a midplane of the tooth. From the figures it should be appreciated that the blade 24 of the present invention is uniform in this dimension across the central face 60 of the top surface from one side face 56 to the other 58. The blade is also uniform in thickness along the central face 38 of the front surface from the bottom surface to the top surface. This avoids weakness along the midplane of the blade tip 24 normal to the disc axis which may lead to premature failure of the part. For example, the tooth of Applicant's U.S. Pat. No. 4,765,217 having concave front and top surfaces was found to have a tendency in some circumstances to break in the center, causing one half of the blade tip to come off the plate.

The chip ejector 68 of the blade tip of the second embodiment acts like a scoop to carry wood chips along the cut for ejection therefrom to prevent chips removed from the body of wood from sliding along the central face 38 of the front surface past the bottom surface 65 where it may become jammed between the plate 26 and the wood on each side of the cut. Such an occurrence causes friction which builds up heat and may cause the saw blade to expand on the outer rim, thereby modifying the tension of the saw blade. The tension of the saw blade is critical for proper operation of the saw blade. The chip ejector helps prevent heat buildup due to friction to keep the saw as cool as possible to maintain a relatively high level of performance. The smooth transition between the curved chip ejector lip and the side faces of the front surface avoids the formation of sharp corners therebetween which may cause chips to become trapped on the front surface and prevent proper ejection from the cut. As explained above, unwanted retention of chips can induce friction and associated problems.

Other embodiments are within the following claims. For example, the saw disc 14 may include integral flanges to support the blade tip, thus avoiding the need for a separate plate such as plate 26. Also, the blade tip may be included on a large disc that can be oriented horizontally to fell standing trees. A cross-cutting saw having a blade disc with generally rounded recesses, as taught in Applicant's U.S. Pat. No. 4,765,217 which is hereby incorporated by reference, may use blade tips as taught in the above detailed embodiments.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A wood-cutting apparatus comprising a disc rotatable about an axis in a predetermined rotational direction, the disc having a plurality of teeth, and each tooth comprising a blade member positioned radially outwardly on the disc, the blade member comprising:
(a) a front surface having a first front surface side edge and a second front surface side edge, each front surface side edge extending in a generally radial direction, the front surface edges being spaced from each other in a direction generally parallel to the axis;
(b) a central front surface connecting region positioned between the first and the second front surface side edges, the front surface connecting region being positioned rearwardly from the front surface side edges in the rotational direction;
(c) a connecting edge extending along a most radially outward extent of the front surface connecting region, the connecting edge forming a first cutting point at its intersection with the first front surface side edge and a second cutting point at its intersection with the second front surface side edge; each of the front surface side edges extending radially outwardly further than the connecting edge; and
(d) a top surface extending from the connecting edge rearwardly, away from the direction of rotation, the top surface slanting radially inwardly front-to-rear;
the top and front surfaces each comprising two side faces disposed on opposite sides of a central face, each side face of the top surface extending radially inwardly from one of the top surface side edges to the central face of the top surface, each side face of the front surface extending rearwardly away from the rotational direction from one of the front surface side edges to the central face of the front surface; and
the central faces being generally planar and meeting to define a linear segment of the connecting edge extending parallel to the axis.

2. The cutting apparatus according to claim 1 wherein each side face is generally planar.

3. The cutting apparatus according to claim 1 wherein a length of the central face of the top surface, measured in the direction of rotation, is uniform between the side faces of the top surface.

4. The cutting apparatus according to claim 1 wherein the central face of the top surface between the side faces of the top surface is rectangular.

5. The cutting apparatus according to claim 1 wherein a thickness of the blade, measured in the direction of rotation, is uniform between the side faces of the top surface

6. The cutting apparatus according to claim 1 wherein the front surface further comprises a chip ejector extending between the side faces of the front surface at an end of the central face of the front surface opposite the connecting edge.

7. The cutting apparatus according to claim 6 the chip ejector is curved between the side faces of the front surface.

8. A tooth for insertion in a wood-cutting apparatus that comprises a disc rotatable in a predetermined direction on an axis, the tooth comprising a blade, the blade comprising:
(a) a front surface having a first front surface side edge and a second front surface side edge, each front surface side edge extending in a generally radial direction, the front surface edges being spaced from each other in a direction generally parallel to the axis;
(b) a central front surface connecting region positioned between the first and the second front surface side edges, the front surface connecting region being positioned rearwardly from the front surface side edges in the rotational direction;
(c) a connecting edge extending along a most radially outward extent of the front surface connecting region, the connecting edge forming a first cutting point at its intersection with the first front surface side edge and a second cutting point at its intersection with the second front surface side edge; each of the front surface side edges extending radially outwardly further than the connecting edge; and
(d) a top surface extending from the connecting edge rearwardly, away from the direction of rotation, the top surface slanting radially inwardly front-to-rear;
the top and front surfaces each comprising two side faces disposed on opposite sides of a central face, each side face of the top surface extending radially inwardly from one of the top surface side edges to the central face of the top surface, each side face of the front surface extending rearwardly away from the rotational direction from one of the front surface side edges to the central face of the front surface; and
the central faces being generally planar and meeting to define a linear segment of the connecting edge extending parallel to the axis.

9. The tooth according to claim 8 wherein each side face is generally planar.

10. The tooth according to claim 8 wherein a length of the central face of the top surface, measured in the direction of rotation, is uniform between the side faces of the top surface.

11. The tooth according to claim 8 wherein the central face of the top surface between the side faces of the top surface is rectangular.

12. The tooth according to claim 8 wherein a thickness of the blade, measured in the direction of rotation, is uniform between the side faces of the top surface.

13. The cutting apparatus according to claim 8 wherein the front surface further comprises a chip ejector extending between the side faces of the front surface at an end of the central face of the front surface opposite the connecting edge.

14. The cutting apparatus according to claim 13 wherein the chip ejector is curved between the side faces of the front surface.
